(19) United States
(12) Patent Application Publication
(10) Pub. No.: US 2024/0075635 A1
(43) Pub. Date: Mar. 7, 2024

(54) END EFFECTOR

(71) Applicant: YAMAHA HATSUDOKI KABUSHIKI KAISHA, Iwata-shi (JP)

(72) Inventors: Yoshinori HARADA, Shizuoka (JP); Taiko NAKATANI, Shizuoka (JP)

(21) Appl. No.: 18/505,828

(22) Filed: Nov. 9, 2023

Related U.S. Application Data
(63) Continuation of application No. PCT/JP2022/019977, filed on May 11, 2022.

(51) Int. Cl. B25J 15/00; B25J 9/16

(52) U.S. Cl. CPC B25J 15/0028; B25J 9/1612; B25J 9/1653; B25J 9/1697

(57) ABSTRACT

An end effector includes an imaging device, first and second contact-move members for grabbing a target object, an actuator, and a control device. When, in an image captured by the imaging device, the target object is located within a target-object-grabbing area between a first-contact-move-member-passage area through which a distal end portion of the first contact-move member passes and a second-contact-move-member-passage area through which a distal end portion of the second contact-move member passes in a predetermined-shaped obstacle exclusion area including the target object, the control device adjusts positions of the first contact-move member and the second contact-move member such that the first and second contact-move members pass through the obstacle exclusion area when the end effector moves to a grabbing position.

### CROSS-REFERENCES TO RELATED APPLICATIONS

This is a continuation-in-part application of International Application No. PCT/JP2022/019977 filed on May 11, 2022, the contents of which are incorporated herein by reference.

### TECHNICAL FIELD

The present teaching relates to an end effector that grabs a target object.

### BACKGROUND ART

Fruits such as strawberries and grapes, and green and yellow vegetables such as asparagus and tomatoes, are delicate and prone to damage as well as have high unit prices, compared with grain such as rice and wheat. Such delicate crops with high unit prices are harvested manually one by one to prevent damage caused to the crops at the time of harvest. Therefore, harvesting, e.g., fruits and green and yellow vegetables, places a large physical burden on a producer, as compared with, e.g., grain that can be harvested efficiently on a large scale by using harvesting machines such as combine harvesters. The physically demanding harvesting operation involves difficulty in securing labor force, and therefore tends to place an increased burden on a producer. Thus, crop harvesting systems using a multi-joint robot arm are known.

The crop harvesting systems are provided with, e.g., a working device and an image processor for harvesting crops at the end of the multi-joint robot arm. The harvesting systems locate the position of a crop to be harvested by the image processor, and perform a harvesting operation by the working device equipped with, e.g., a claw for grabbing a crop. Crops have different shapes and are placed in different situations when they are harvested. Thus, harvesting systems, which change a motion stroke of, e.g., the claw of the working device in accordance with the shape of a crop to be harvested, are known.

A cotton harvesting system described in Patent Document 1 has a robot arm, a picking unit (end effector) for harvesting cotton, a stereo camera, and a controller. The controller of the harvesting system calculates, based on an image of cotton captured by the stereo camera, the position and size of the imaged cotton. The controller adjusts the open and closed positions of claws based on the size of the cotton. Thus, the cotton harvesting system can reliably harvest the cotton by changing the open and closed positions of the claws based on the size of the cotton.

### CITATION LIST

### Patent Document

Patent Document 1: Chinese Patent Application Publication No. 113330915

### SUMMARY OF INVENTION

### Technical Problem

In the harvesting system of Patent Document 1, the open positions of the claws of the picking unit are adjusted based on the size of the crop. That is, in the harvesting system, the open positions of the claws are unadjusted in consideration of the condition of, e.g., leaves, rachises, main stems, and branches located around the crop. Therefore, the harvesting system has a high possibility of damaging, e.g., the leaves, rachises, main stems, and branches located in a movement space where the claws move, due to contact of the claws with, e.g., the leaves, rachises, main stems, and branches in the process of the picking unit approaching the crop. In addition, the harvesting system are, in some cases, unable to bring the picking unit closer to the harvesting position because, e.g., the leaves, rachises, main stems, and branches around the crop are obstacles to the claws.

Furthermore, since the harvesting system adjusts the open positions of the claws based on the size of the crop, the range in which the picking unit can grab the crop is narrower than when the claws are opened to their widest extent. Therefore, the harvesting system may be unable to grab the crop by the picking unit if there is a large calculation error in the position of the crop calculated based on the image captured by the stereo camera, or if the positioning precision of the picking unit with respect to the crop is low. Accordingly, the harvesting system calculates the position of the crop with high precision and also interlocks respective axes of the multi-joint robot arm with high precision to grab the crop while avoiding interference between the claws and obstacles around the crop. This leads to a reduced speed of movement of the picking unit moved by the multi-joint robot arm in the harvesting system, resulting in a lower number of crops harvested per unit of time.

It is an object of the present teaching to provide an end effector that can improve a harvest rate of a target object by suppressing interference with, e.g., leaves, rachises, main stems, and branches located around the target object without highly precisely moving a work machine that moves the end effector.

### Solution to Problem

The inventors of the present teaching studied an end effector capable of improving a harvest rate of a target object by suppressing interference with, e.g., leaves, rachises, main stems, and branches located around the target object without highly precisely moving a work machine that moves the end effector. Through an intensive study, the inventors arrived at the configuration as described below.

An end effector according to one embodiment of the present teaching is movable by a work machine for grabbing a target object, and comprises: a body member configured to be supported by the work machine; a target-object-positioning mechanism coupled to the body member; an imaging device provided at the body member, the imaging device being configured to capture an image including the target object at an imaging position; and a control device configured to control the target-object-positioning mechanism based on the image captured by the imaging device.

The target-object-positioning mechanism includes: a contact-move member configured to make contact with at least a part of the target object, to thereby grab the target object at a grabbing position, the contact-move member including a first contact-move member configured to move in a first direction with respect to the body member, the first direction being orthogonal to a front-rear direction which is a direction from the body member to the grabbing position or from the grabbing position to the body member, a second contact-move member configured to move in a second direction orthogonal to the front-rear direction, and an actuator configured to move the first contact-move member in the first direction and to move the second contact-move member in the second direction.

The control device is configured to obtain in the image, by processing the image, a passage area through which the first contact-move member and the second contact-move member are predicted to pass when the end effector is moved from the imaging position to the grabbing position and when the first contact-move member and the second contact-move member are moved with the end effector located at the grabbing position, the passage area including an obstacle exclusion area that has a predetermined shape, and that includes the target object but is free of any obstacle that obstructs movement of the first contact-move member and the second contact-move member, wherein the obstacle exclusion area includes a first-contact-move-member-passage area that is free of the target object and through which a distal end portion of the first contact-move member is predicted to pass, a second-contact-move-member-passage area that is free of the target object and through which a distal end portion of the second contact-move member is predicted to pass, and a target-object-grabbing area located between the first-contact-move-member-passage area and the second-contact-move-member-passage area, the target object being in the target-object-grabbing area, the control device is further configured to cause at least one of the first contact-move member or the second contact-move member to move with respect to the body member by the actuator, such that the first contact-move member passes through a first space that is defined by extending the first-contact-move-member-passage area in a moving direction of the end effector, and the second contact-move member passes through a second space that is defined by extending the second-contact-move-member-passage area in the moving direction of the end effector, when the end effector is moved from the imaging position to the grabbing position.

In the image with the target object viewed from the imaging position, the end effector changes positions of the first contact-move member and the second contact-move member such that, the first contact-move member passes through the first space and the second contact-move member passes through the second space, in the obstacle exclusion area that is free of the obstacles in the passage area through which the first contact-move member and the second contact-move member are predicted to pass. Therefore, linear movement of the end effector from the imaging position to the grabbing position allows the end effector to position the target object between the first contact-move member and the second contact-move member at the grabbing position without contact of the first and second contact-move members with, e.g., stems and branches. Thus, simply by moving the end effector linearly by the work machine, the end effector can position the target object at a position where the target object can be grabbed by the first contact-move member and the second contact-move member. It is, therefore, possible to suppress interference between the end effector and the obstacles around the target object without highly precisely moving the work machine that moves the end effector. This can improve a harvest rate of the target object.

In another aspect, the end effector according to the present teaching preferably includes the following configuration. The control device is further configured to obtain in the image, by processing the image, a maximum passage area through which the first contact-move member and the second contact-move member with a widest interval therebetween are predicted to pass when the end effector is moved from the imaging position to the grabbing position and when the first contact-move member and the second contact-move member are moved with the end effector located at the grabbing position, and change at least one of a position, an angle, or a size of the maximum passage area to position the target object within the target-object-grabbing area.

As described above, the control device of the end-effector changes at least one of the position, the rotation angle, or the size of the maximum passage area in the image to thereby set the obstacle exclusion area that is free of obstacles, the first-contact-move-member-pas sage area and the second-contact-move-member-passage area included in the obstacle exclusion area, and the target-object-grabbing area which is included in the obstacle exclusion area and includes the target object. Therefore, the end effector can set the first-contact-move-member-passage area, the second-contact-move-member-passage area, and the target-object-grabbing area where the target object can be grabbed, based on the positions of the object and the obstacles in the image. This can suppress interference between the end effector and the obstacles around the target object without highly precisely moving the work machine that moves the end effector. It is, therefore, possible to improve the harvest rate of the target object.

In another aspect, the end effector according to the present teaching preferably includes the following configuration. The control device is configured to change at least one of a position, an angle, or a size of the obstacle exclusion area with respect to the target object, to thereby maximize an interval between the first-contact-move-member-passage area and the second-contact-move-member-passage area when the end effector is moved from the imaging position to the grabbing position with the target object located within the target-object-grabbing area in the image. The control device is configured to cause at least one of the first contact-move member or the second contact-move member to move by the actuator such that the first contact-move member passes through the first space and the second contact-move member passes through the second space, in the changed obstacle exclusion area.

As described above, the control device of the end effector sets the obstacle exclusion area such that an interval between the first-contact-move-member-passage area and the second-contact-move-member-passage area is maximized by changing at least one of the position, the rotation angle, or the size of the obstacle exclusion area with respect to the target object with the target object as a reference in the image. Therefore, the end effector is positioned at the grabbing position by effectively using the areas through which the first contact-move member and the second contact-move member can pass with the target object as a reference. This can suppress interference between the end effector and the obstacles around the target object without highly precisely moving the work machine that moves the end effector. It is, therefore, possible to improve the harvest rate of the target object.

In another aspect, the end effector according to the present teaching preferably includes the following configuration. The obstacle exclusion area is of a polygonal shape or a circular shape.

As described above, the obstacle exclusion area is polygonal or circular shaped in accordance with an area that is free of obstacles, based on the positions of the target object and the obstacles. Therefore, the end effector can make the interval between the first contact-move member and the second contact-move member as wide as possible by effectively using the areas through which the first contact-move member and the second contact-move member can pass with the target object as a reference. This can suppress interference between the end effector and the obstacles around the target object without highly precisely moving the work machine that moves the end effector. It is, therefore, possible to increase a rate of grabbing the target object.

In another aspect, the end effector according to the present teaching preferably includes the following configuration. The first-contact-move-member-passage area and the second-contact-move-member-passage area are located around the target-object-grabbing area.

As described above, the first-contact-move-member-passage area and the second-contact-move-member-passage area in the image are so located to surround the target-object-grabbing area. That is, the end effector can position the first-contact-move member and the second-contact-move member such that the target object is located between these members, at the grabbing position. This can suppress interference between the end effector and the objects around the target object without highly precisely moving the work machine that moves the end effector. It is, therefore, possible to improve the harvest rate of the target object.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of an end effector according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

[End Effector]

An end effector herein refers to a device for performing arbitrary processing on a target object. The end effector is attached to an end of a work machine such as a multi-joint robot arm. The end effector has a configuration that corresponds to processing performed on the target object, and includes various devices corresponding to the various types of processing.

[Target Object]

A target object herein refers to a target to be imaged for calculation of distance information by a stereo camera. The target object includes, for example, a fruit, a trunk, a stem, a branch, and a stalk in an agricultural work.

[Obstacle]

An obstacle herein refers to an object except the target object and in contact with a contact-move member of the end effector when the contact-move member moves from an imaging position at which the target object is imaged toward a grabbing position in order to grab the target object. That is, the obstacle includes, e.g., a trunk, a stem, a branch, and a stalk located in an area through which the contact-move member passes, when the end effector moves from the imaging position at which the target object is imaged toward the grabbing position.

[Target-Object-Positioning Mechanism]

A target-object-positioning mechanism herein refers to a mechanism for positioning the target object at a processing position in the end effector. The target-object-positioning mechanism has a function of grabbing the target object at the grabbing position. The target-object-positioning mechanism may have a function of moving the grabbed target object from the grabbing position to the processing position. The target-object-positioning mechanism has a function of holding the target object.

[Work Machine]

A work machine herein refers to a machine for moving the end effector to a predetermined position to allow the end effector to perform the processing on the target object. As the work machine, a machine capable of moving the end effector suffices, such as a robot arm, an unmanned flight vehicle, and an unmanned ground vehicle.

[Maximum Passage Area]

A maximum passage area herein refers to a passage area through which the first contact-move member and the second contact-move member are predicted to pass when they have the widest interval therebetween, in an image captured by an imaging device. The passage area includes areas through which a first contact-move member and a second contact-move member are predicted to pass when the first contact-move member and the second contact-move member move from the imaging position of the image to the grabbing position of the target object, and an area through which the first contact-move member and the second contact-move member are predicted to pass when the first contact-move member and the second contact-move member move in a direction approaching each other at the grabbing position. The maximum passage area is an area including the target object in the image captured by the imaging device. The maximum passage area is an area that may include an obstacle obstructing movement of the first contact-move member and the second contact-move member in the image captured by the imaging device.

[Obstacle Exclusion Area]

An obstacle exclusion area herein refers to, in the image captured by the imaging device, an area that is free of any obstacle obstructing the first contact-move member and the second contact-move member when these members move from the imaging position of the image to the grabbing position of the target object. The obstacle exclusion area includes a target-object-grabbing area at which the target object is located, a first-contact-move-member-passage area through which the first contact-move-member passes, and a second-contact-move-member-passage area through which the second contact-move-member passes. In other words, the obstacle exclusion area refers to an area having a predetermined shape larger than the target object in the image, and through which the first contact-move member and the second contact-move member can pass.

### Advantageous Effects of Invention

According to one embodiment of the present teaching, it is possible to suppress interference between the end effector and objects around the target object without highly precisely moving the work machine that moves the end effector.

### BRIEF DESCRIPTION OF DRAWINGS

FIG. 1 is a plan view of an end effector according to the present teaching.

FIG. 2 is a side view of the end effector according to the present teaching.

FIG. 3 is a block diagram showing a control configuration of the end effector according to the present teaching.

FIG. 4 is a schematic view showing a captured image and contact-move-member-pas sage areas in a grabbing control of the end effector, in a first embodiment of the present teaching.

FIG. 5 is schematic views showing a target-object-positioning mechanism in which an interval between first and second contact-move members is unadjusted with respect to the contact-move member-passage areas, and the target-object-positioning mechanism in which the interval has been adjusted with respect to the contact-move member-passage areas in the grabbing control of the end effector, in the first embodiment of the present teaching.

FIG. 6 is schematic views showing a maximum passage area and a reference-obstacle-exclusion area in a contact-move-member-adjusting control of the end effector, in a second embodiment of the present teaching.

FIG. 7 is schematic views showing a position of a contact-move member with respect to the maximum passage area and the reference-obstacle-exclusion area in the contact-move-member-adjusting control of the end effector, in the second embodiment of the present teaching.

FIG. 8 is schematic views showing the reference-obstacle-exclusion area and a corrected-obstacle-exclusion area in a contact-move-member-adjusting control of the end effector, in a third embodiment of the present invention.

FIG. 9 is schematic views showing a position of the contact-move member with respect to the reference-obstacle-exclusion area and the corrected-obstacle-exclusion area in the contact-move-member-adjusting control of the end effector according to the third embodiment of the present teaching.

FIG. 10 is a schematic view showing the end effector supported by a multi-joint robot arm device.

FIG. 11 is a block diagram showing the control configuration of the end effector according to the present teaching, as well as schematic views showing the contact-move-member-passage areas, the contact-move member before adjustment, and the contact-move member after adjustment.

### DESCRIPTION OF EMBODIMENTS

Embodiments will be described hereinafter with reference to the drawings. In the drawings, the same or corresponding parts are denoted by the same reference numerals, and description thereof will not be repeated. The dimensions of components in the drawings do not strictly represent, e.g., actual dimensions of the components and dimensional proportions of the components.

### First Embodiment

<Overall Configuration>

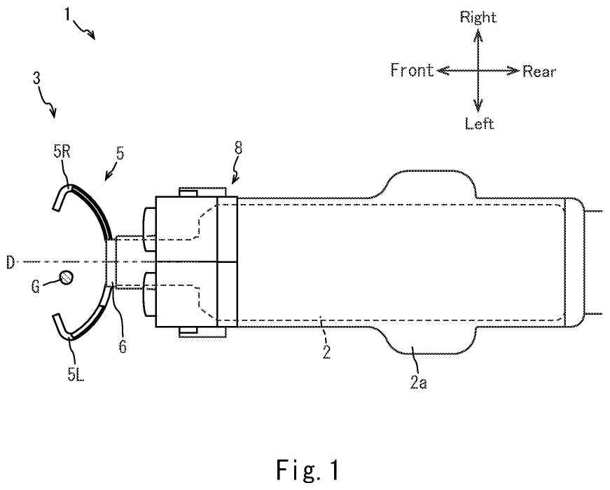

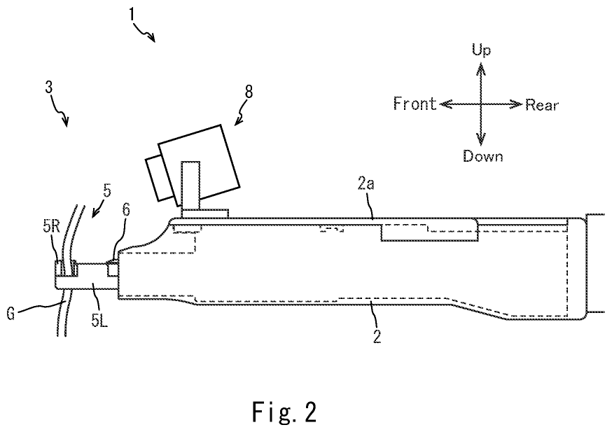

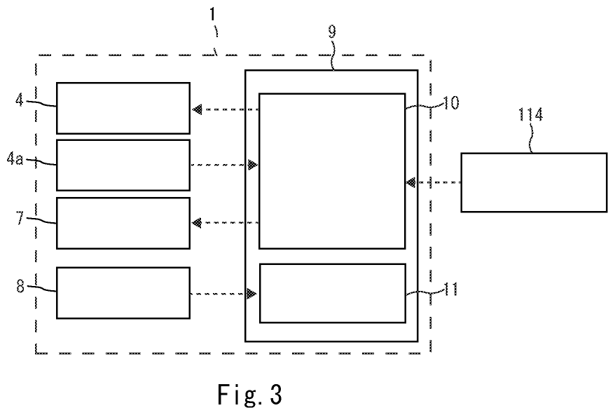

An end effector 1 according to a first embodiment of the present teaching will be described with reference to FIGS. 1 to 3. FIG. 1 is a plan view of the end effector 1. FIG. 2 is a side view of the end effector 1. FIG. 3 is a block diagram showing a control configuration of the end effector 1.

Hereinafter, arrow “Front” in the drawings indicates a forward direction of the end effector 1. Arrow “Rear” in the drawings indicates a rearward direction of the end effector 1. Arrow “Up” in the drawings indicates an upward direction of the end effector 1. Arrow “Down” in the drawings indicates a downward direction of the end effector 1. A front-rear direction of the end effector 1 is defined such that the forward direction of the end effector 1 is a direction in which a target-object-positioning mechanism 3 moves from a body member 2 to a grabbing position P2 at which to grab a grape stem G, while the rearward direction of the end effector 1 is a direction in which the target-object-positioning mechanism 3 moves from the grabbing position P2 to the body member 2, i.e., the direction in which the end effector 1 moves from an imaging position P1 to the grabbing position P2 or from the grabbing position P2 to the imaging position P1. A left-right direction of the end effector 1 is a direction perpendicular to the front-rear direction and an up-down direction of the end effector 1, where the vertical direction is defined as the up-down direction. In the following embodiments, “clockwise” refers to right-hand rotation when viewing downward from above in the up-down direction. “Counterclockwise” refers to left-hand rotation when viewing downward from above in the up-down direction.

As shown in FIGS. 1 and 2, the end effector 1 is a device for grabbing, for example, a grape stem G (hereinafter referred to as “stem G”) as a target object. The end effector 1 is supported by a work machine that can move the end effector 1. In this embodiment, the end effector 1 grabs the stem G based on an image I captured by a stereo camera 8 that is an imaging device. The end effector 1 includes a body member 2, the target-object-positioning mechanism 3, a processing mechanism 6, the stereo camera 8, and a control device 9.

The body member 2 is a component that constitutes a casing of the end effector 1. The casing that constitutes the body member 2 is sized to allow the target-object-positioning mechanism 3, an actuator 4 for the positioning mechanism (positioning mechanism actuator 4), and the processing mechanism 6 to be accommodated therein. The target-object-positioning mechanism 3, the positioning mechanism actuator 4, and the processing mechanism 6 are accommodated inside the body member 2. A cover 2a is attached to an opening area of the body member 2.

<Target-Object-Positioning Mechanism>

As shown in FIGS. 1 and 3, the target-object-positioning mechanism 3 is a mechanism for positioning the stem G. The target-object-positioning mechanism 3 includes the positioning mechanism actuator 4, a contact-move member 5, and a contact-move mechanism (not shown).

The positioning mechanism actuator 4 (see FIG. 3) is a driving source of the target-object-positioning mechanism 3. The positioning mechanism actuator 4 is, for example, an electric cylinder. The positioning mechanism actuator 4 includes an encoder 4a that detects an amount of rotation of an electric motor that moves a piston of the electric cylinder or an amount of movement of a piston rod. The positioning mechanism actuator 4 is supplied with electric power from an actuator control unit 10 included in the control device 9. The encoder 4a outputs a position signal of the electric cylinder to the actuator control unit 10. The positioning mechanism actuator 4 is thereby position-controlled by the actuator control unit 10.

The contact-move member 5 is a member for grabbing the stem G. The contact-move member 5 includes a first contact-move member 5L and a second contact-move member 5R. The first contact-move member 5L and the second contact-move member 5R are, for example, rectangular plate-like members that are curved.

The first contact-move member 5L, which constitutes a part of the contact-move member 5, is a member approaching the stem G from the left of the stem G by a driving force of the positioning mechanism actuator 4. The first contact-move member 5L is located approximately at the center in the left-right direction of a front end portion of the body member 2. The first contact-move member 5L is supported by the body member 2 so as to be rotatable with respect to the body member 2 with an axis perpendicular to the front-rear direction and the left-right direction as a rotation center.

A distal end portion of the first contact-move member 5L is located further leftward than a reference line D that is orthogonal to the axis and extends in the front-rear direction. That is, the first contact-move member 5L is located progressively to the left from a portion rotatably supported by the body member 2 toward the distal end portion in a state of extending in the forward direction. The first contact-move member 5L is connected to the positioning mechanism actuator 4.

The second contact-move member 5R, which constitutes a part of the contact-move member 5, is a member approaching the stem G from the right of the stem G by a driving force of the positioning mechanism actuator 4. The second contact-move member 5R is located approximately at the center in the left-right direction of the front end portion of the body member 2. The second contact-move member 5R is supported by the body member 2 so as to be rotatable with respect to the body member 2 with the axis as a rotation center.

A distal end portion of the second contact-move member 5R is located further rightward than the reference line D. That is, the second contact-move member 5R is located progressively to the right from a proximal end portion rotatably supported by the body member 2 toward the distal end portion in a state of extending in the forward direction. The second contact-move member 5R is connected to the positioning mechanism actuator 4.

The first contact-move member 5L is configured such that the distal end portion thereof is rotatable in a direction approaching the reference line D (clockwise) and in a direction away from the reference line D (counterclockwise) by the positioning mechanism actuator 4. The second contact-move member 5R is configured such that the distal end portion thereof is rotatable in a direction approaching the reference line D (counterclockwise) and in a direction away from the reference line D (clockwise) by the positioning mechanism actuator 4. That is, the first contact-move member 5L and the second contact-move member 5R are configured such that their distal end portions are each movable in a left direction and in a right direction by the positioning mechanism actuator 4.

The first contact-move member 5L and the second contact-move member 5R are configured to move in an opposite direction to each other by the positioning mechanism actuator 4. The first contact-move member 5L moves in the right direction that is a first direction from the left of the reference line D toward the reference line D by the positioning mechanism actuator 4. Simultaneously, the second contact-move member 5R moves in the left direction that is a second direction from the right of the reference line D toward the reference line D. The first contact-move member 5L and the second contact-move member 5R are configured to be movable by the same amount of movement in a direction approaching each other or in a direction away from each other in the left-right direction by the positioning mechanism actuator 4.

The target-object-positioning mechanism 3 thus configured allows the first contact-move member 5L and the second contact-move member 5R to change between an opened state in which they are positioned apart from each other and a closed state in which they are positioned close to each other, by the positioning mechanism actuator 4. The target-object-positioning mechanism 3 can arbitrarily change an angle of each of the first contact-move member 5L and the second contact-move member 5R to the reference line D by the positioning mechanism actuator 4. That is, the target-object-positioning mechanism 3 can arbitrarily change an interval in the left-right direction between the reference line D and each of the distal end portions of the first and second contact-move members 5L, 5R.

The processing mechanism 6 is a mechanism for performing cutting processing on the stem G. The processing mechanism 6 cuts the stem G by means of a processing blade driven by an actuator 7 for the processing mechanism (processing mechanism actuator 7).

The processing mechanism actuator 7 (see FIG. 3) is a driving source of the processing mechanism 6. The processing mechanism actuator 7 is, for example, an electric cylinder. The processing mechanism actuator 7 is supplied with electric power from the actuator control unit 10 included in the control device 9. The processing mechanism actuator 7 is thereby controlled by the actuator control unit 10.

The stereo camera 8 is an imaging device capable of measuring a distance to the stem G present in a predetermined space. The stereo camera 8 captures the image I. The stereo camera 8 is fixed to the body member 2. The stereo camera 8 is configured to be capable of imaging the front of the end effector 1. The stereo camera 8 outputs the captured image to an image processing unit 11 included in the control device 9.

As shown in FIG. 3, the control device 9 controls the positioning mechanism actuator 4 for the target-object-positioning mechanism 3, the processing mechanism actuator 7 for the processing mechanism 6, and the stereo camera 8. The control device 9 includes the actuator control unit 10 and the image processing unit 11. The control device 9 integrally controls the actuator control unit 10 and the image processing unit 11. The control device 9 is electrically connected to the work machine's control device that is a higher-level control device by, e.g., a signal line. A control signal related to a grabbing control of the stem G is input to the control device 9 from the control device of the work machine. The control device 9 outputs a control signal related to the grabbing of the stem G to the control device of the work machine.

The actuator control unit 10 controls the positioning mechanism actuator 4 and the processing mechanism actuator 7. The actuator control unit 10 is electrically connected to the positioning mechanism actuator 4 and the processing mechanism actuator 7 by power lines. The actuator control unit 10 is electrically connected to the encoder 4a of the positioning mechanism actuator 4 by a signal line.

A position signal is input to the actuator control unit 10 from the encoder 4a. The actuator control unit 10 controls an amount of movement of the positioning mechanism actuator 4 based on the position signal input from the encoder 4a. This allows the actuator control unit 10 to adjust the positions, with respect to the body member 2, of the first contact-move member 5L and the second contact-move member 5R that are moved by the positioning mechanism actuator 4. That is, the actuator control unit 10 can arbitrarily change an interval in the left-right direction between the distal end portion of the first contact-move member 5L and the distal end portion of the second contact-move member 5R.

When the first contact-move member 5L and the second contact-move member 5R grabs the stem G, a predetermined position signal is input to the actuator control unit 10 from the encoder 4a, and the actuator control unit 10 then moves the processing mechanism actuator 7 by a predetermined amount. This allows the actuator control unit 10 to move the processing blade to the processing position by the processing mechanism actuator 7.

The image processing unit 11 processes the image I captured by the stereo camera 8. The image processing unit 11 stores in advance data for detecting the stem G acquired by learning about various images of the stem G. The image processing unit 11 has an image processing program for processing the input image I.

The image processing unit 11 is electrically connected to the stereo camera 8 by a signal line. An image captured by each of a pair of monocular cameras of the stereo camera 8 is input to the image processing unit 11. The image processing unit 11 can detect the stem G from the input image I, using the image processing program. Furthermore, the image processing unit 11 can calculate a distance to the stem G using the image processing program.

The image processing unit 11 can obtain in the image I, by processing the image I using the image processing program, a passage area through which the first contact-move member 5L and the second contact-move member 5R are predicted to pass when the first contact-move member 5L and the second contact-move member 5R are moved from the imaging position P1 to the grabbing position P2 by the work machine and when the first contact-move member 5L and the second contact-move member 5R are moved in the direction approaching each other at the grabbing position P2 by the positioning mechanism actuator 4, while these members are located at an arbitrary interval therebetween in the left-right direction. The image processing unit 11 can also obtain, by image processing, an obstacle exclusion area B of a predetermined shape with the stem G as a reference in the predicted passage area. The obstacle exclusion area B includes the stem G, but is free of any obstacle obstructing movement of the first contact-move member 5L and the second contact-move member 5R.

The predetermined shape is, for example, a rectangle constituted by sides extending in the left-right direction of the end effector 1, which is the moving direction of the first contact-move member 5L and the second contact-move member 5R, and sides extending in the up-down direction orthogonal to the left-right direction, in the image I.

A width in the left-right direction of the obstacle exclusion area B is defined, for example, by an interval between a left outer end of an area through which the distal end portion of the first contact-move member 5L is predicted to pass and a right outer end of an area through which the distal end portion of the second contact-move member 5R is predicted to pass while these members are located at an arbitrary interval therebetween in the left-right direction with the stem G as a reference in the image I. A width in the up-down direction of the obstacle exclusion area B is defined, for example, by a width between an upper outer end and a lower outer end of the rectangular area that is free of any obstacle with the stem G as a reference in the image I.

The image processing unit 11 can obtain, by image processing, a first-contact-move-member-passage area A21 having a predetermined shape in the obstacle exclusion area B of the image I by using the image processing program, where the first-contact-move-member-passage area A21 is an area that is free of the stem G and through which the distal end portion of the first contact-move member 5L is predicted to pass when the first contact-move member 5L moves from the imaging position P1 to the grabbing position P2. The first-contact-move-member-passage area A21 is, for example, a rectangular area extending in the up-down direction and in the left-right direction in the obstacle exclusion area B. The first-contact-move-member-passage area A21 is, for example, an area extending from an upper outer end to a lower outer end of the obstacle exclusion area B. The first-contact-move-member-passage area A21 is, for example, an area extending from a left outer end of the obstacle exclusion area B to the right.

The image processing unit 11 can obtain, by image processing, a second-contact-move-member-passage area A22 having a predetermined shape in the obstacle exclusion area B of the image I by using the image processing program, where the second-contact-move-member-passage area A22 is an area that is free of the stem G and through which the distal end portion of the second contact-move member 5R is predicted to pass when the second contact-move member 5R moves from the imaging position P1 to the grabbing position P2. The second-contact-move-member-passage area A22 is, for example, a rectangular area extending in the up-down direction and in the left-right direction in the obstacle exclusion area B. The second-contact-move-member-passage area A22 is, for example, an area extending from the upper outer end to the lower outer end of the obstacle exclusion area B. The second-contact-move-member-passage area A22 is, for example, an area extending from a right outer end of the obstacle exclusion area B to the left.

The image processing unit 11 can obtain, by image processing, a target-object-grabbing area A1 that is an area located between the first-contact-move-member-passage area A21 and the second-contact-move-member-passage area A22 and including the stem G, in the obstacle exclusion area B of the image I, by using the image processing program. The target-object-grabbing area A1 is located adjacent to the first-contact-move-member-passage area A21 and the second-contact-move-member-passage area A22.

In the obstacle exclusion area B of the image I, the first-contact-move-member-passage area A21 is adjacent to the left of the target-object-grabbing area A1. Therefore, the first-contact-move-member-passage area A21 is an area extending from the left outer end of the obstacle exclusion area B to a left outer end of the target-object-grabbing area A1. In the obstacle exclusion area B of the image I, the second-contact-move-member-passage area A22 is adjacent to the right of the target-object-grabbing area A1. Therefore, the second-contact-move-member-passage area A22 is an area extending from the right outer end of the obstacle exclusion area B to a right outer end of the target-object-grabbing area A1.

The left outer end of the target-object-grabbing area A1 is defined by a right outer end of the first-contact-move-member-passage area A21 located at the left of the obstacle exclusion area B. The right outer end of the target-object-grabbing area A1 is defined by a left outer end of the second-contact-move-member-passage area A22 located at the right of the obstacle exclusion area B. When the first contact-move member 5L and the second contact-move member 5R are located at the grabbing position P2, the stem G in the target-object-grabbing area A1 is located between the first contact-move member 5L and the second contact-move member 5R.

<Contact-Move-Member-Adjusting Control>

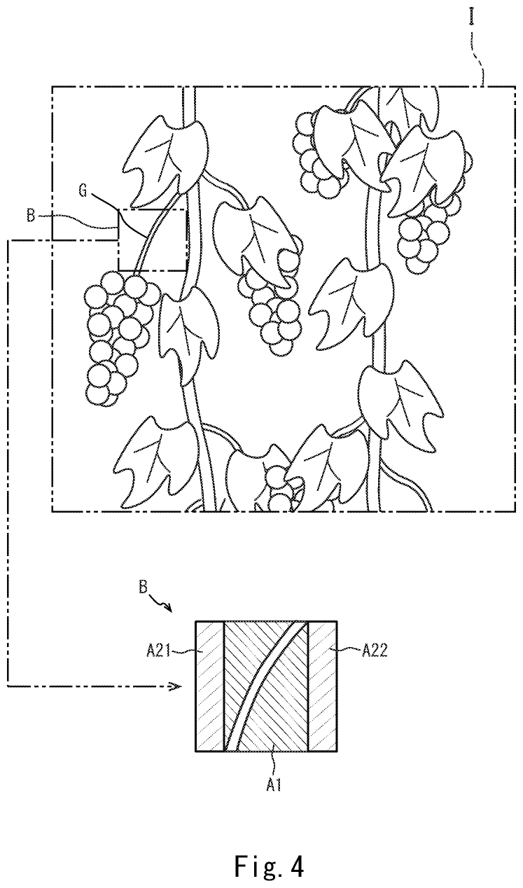

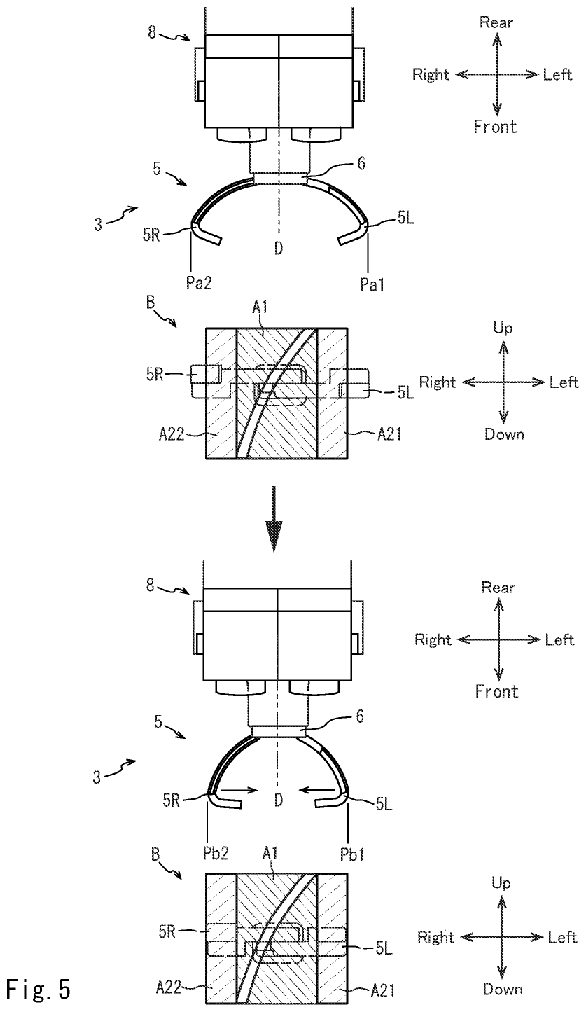

Next, a contact-move-member-adjusting control of the end effector 1 will be described with reference to FIGS. 1 to 5. FIG. 4 is a schematic view showing the captured image I and the obstacle exclusion area B in the grabbing control of the end effector 1. FIG. 5 is schematic views showing the target-object-positioning mechanism 3 before an interval between the first contact-move member 5L and the second contact-move member 5R is adjusted and the target-object-positioning mechanism 3 after the interval is adjusted, with respect to the obstacle exclusion area B.

The end effector 1 is supported by the work machine, such as a multi-joint robot arm, that can move the end effector 1 to an arbitrary position. The end effector 1 is positioned at the imaging position P1 at which the stem G is included in an imaging range of the stereo camera 8. The first contact-move member 5L is located at a first initial position Pa1 that is the leftmost position within its movable range in the left direction or in the right direction. The second contact-move member 5R is located at a second initial position Pa2 that is the rightmost position within its movable range in the left direction or in the right direction.

As shown in FIG. 3, when a control signal to start the grabbing control of the stem G is input from the control device of the work machine, the control device 9 outputs to the stereo camera 8 a signal to image a range where the stem G is located by means of the image processing unit 11.

When the location, at which the end effector 1 is positioned, is set as the imaging position P1, the stereo camera 8 captures the image I that includes the stem G at the imaging position P1 in an arbitrary posture with respect to the stem G. The stereo camera 8 outputs data of the captured image I to the image processing unit 11.

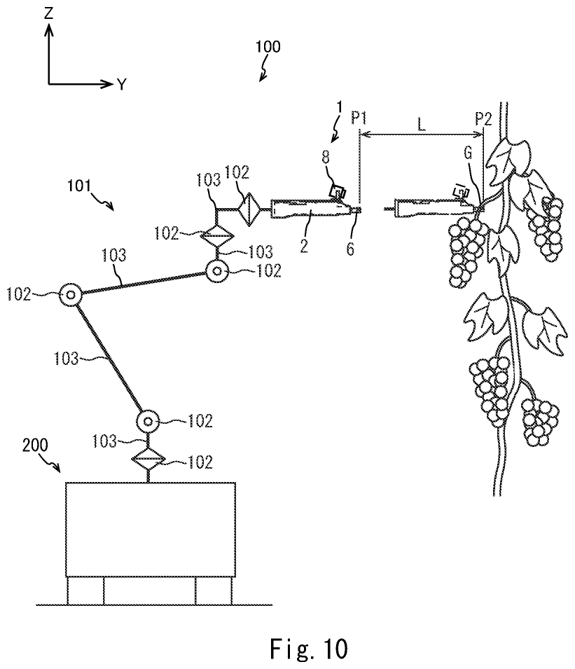

The image processing unit 11 detects the stem G from the data of the image I input from the stereo camera 8 by using the image processing program. Furthermore, the image processing unit 11 calculates a distance L from the imaging position P1 to the stem G at the grabbing position P2 based on the image processing program (see FIG. 10).

As shown in FIGS. 3 and 4, the image processing unit 11 obtains, by image processing, the obstacle exclusion area B with the stem G as a reference in the image I by using the image processing program, where the obstacle exclusion area B has the predetermined shape and includes the target-object-grabbing area A1, the first-contact-move-member-passage area A21, and the second-contact-move-member-passage area A22.

The image processing unit 11 obtains, by image processing, the target-object-grabbing area A1 including the stem G in the obstacle exclusion area B of the image I. Furthermore, the image processing unit 11 obtains, by image processing, the first-contact-move-member-passage area A21 and the second-contact-move-member-passage area A22 in the obstacle exclusion area B of the image I, with the target-object-grabbing area A1 as a reference.

As shown in FIGS. 3 and 5, the control device 9 obtains, based on information such as a position, a size, and a shape of the obstacle exclusion area B, and the distance L, a first adjusted position Pb1 that is a position, with respect to the body member 2, of the first contact-move member 5L passing through a first space that is defined by extending the first-contact-move-member-passage area A21 in the moving direction when the end effector 1 moves from the imaging position P1 to the grabbing position P2. Similarly, the control device 9 obtains a second adjusted position Pb2 that is a position, with respect to the body member 2, of the second contact-move member 5R passing through a second space that is defined by extending the second-contact-move-member-passage area A22 in the moving direction when the end effector 1 moves from the imaging position P1 to the grabbing position P2.

The control device 9 supplies electric power to the positioning mechanism actuator 4 by the actuator control unit 10 based on the obtained first adjusted position Pb1 and second adjusted position Pb2. The positioning mechanism actuator 4 moves the first contact-move member 5L from the first initial position Pa1 toward the first adjusted position Pb1 in the direction approaching the reference line D. Similarly, the positioning mechanism actuator 4 moves the second contact-move member 5R from the second initial position Pa2 toward the second adjusted position Pb2 in the direction approaching the reference line D.

The encoder 4a outputs a position signal to the actuator control unit 10. When the actuator control unit 10 determines, based on the input position signal, that the first contact-move member 5L is positioned at the first adjusted position Pb1 and the second contact-move member 5R is positioned at the second adjusted position Pb2, the actuator control unit 10 stops supplying electric power to the positioning mechanism actuator 4. The control device 9 outputs a control signal to terminate the contact-move-member-adjusting control to the control device (robot-arm-control device 114) of the work machine.

The end effector 1 is moved by the work machine from the imaging position P1 to the grabbing position P2. At this time, the distal end portion of the first contact-move member 5L passes through the first space. The distal end portion of the second contact-move member 5R passes through the second space. At the grabbing position P2, the first contact-move member 5L and the second contact-move member 5R are moved in the direction approaching each other by the positioning mechanism actuator 4 and make contact with a part of the stem G. Therefore, until the first contact-move member 5L and the second contact-move member 5R are positioned at the grabbing position P2 away from the imaging position P1, their contact with obstacles is suppressed.

The first-contact-move-member-passage area A21 is located in a left end portion of the obstacle exclusion area B in the image I. The second-contact-move-member-passage area A22 is located in a right end portion of the obstacle exclusion area B in the image I. Therefore, the interval between the first contact-move member 5L and the second contact-move member 5R is the widest within the obstacle exclusion area B where contact with the obstacles is suppressed. In addition, the first contact-move member 5L and the second contact-move member 5R are located the farthest from the stem G within the obstacle exclusion area B. Therefore, the end effector 1 can maximize a range in which the stem G can be grabbed, within a range in which the first contact-move member 5L and the second contact-move member 5R are free of contact with the obstacles.

The end effector 1 thus configured can suppress contact with objects except the stem G by adjusting the positions of the first contact-move member 5L and the second contact-move member 5R based on the obstacle exclusion area B set in the image I. That is, the end effector 1 can set an allowable amount of deviation in position of the end effector 1 from the stem G within which the end effector 1 can grab the stem G, in consideration of surrounding conditions of the stem G. This can suppress damage to, e.g., leaves, rachises, main stems, and branches located around the stem G without highly precisely moving the work machine that moves the end effector 1. It is, therefore, possible to improve a harvest rate of, e.g., fruit with the stem G by the end effector 1.

### Second Embodiment

<Change in Obstacle Exclusion Area>

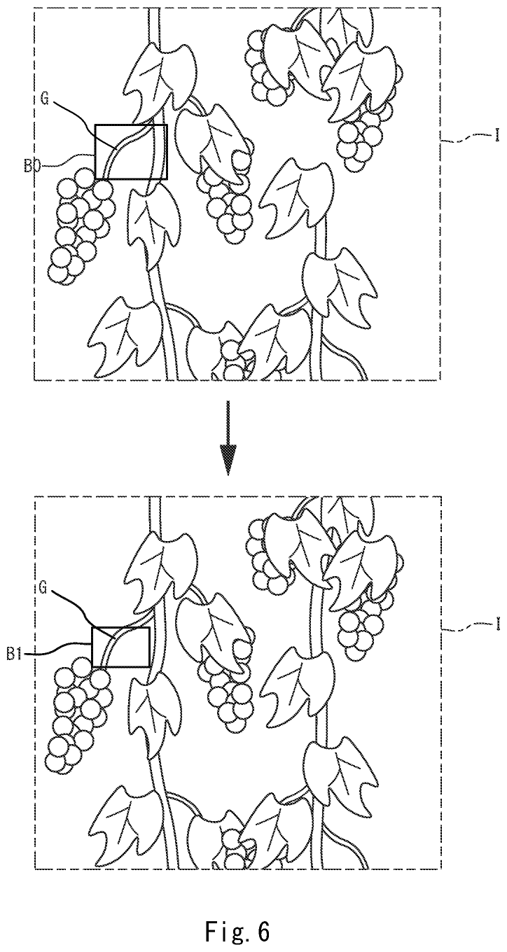

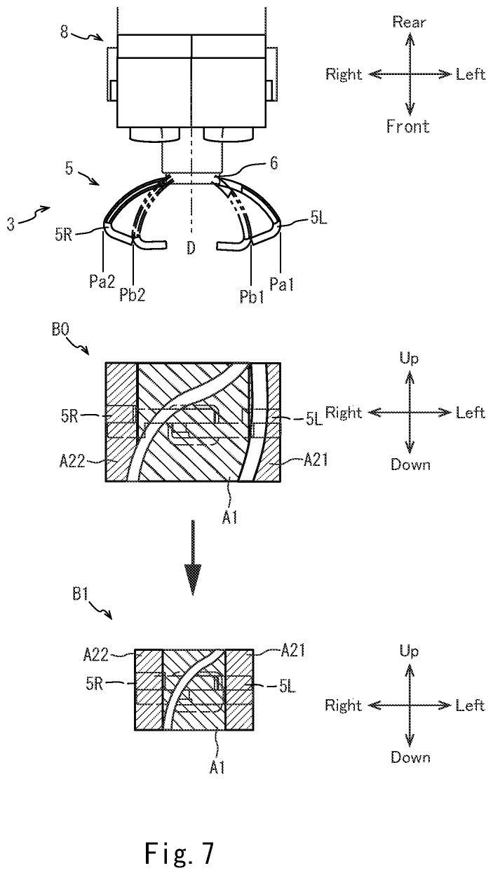

A contact-move-member-adjusting control of the end effector 1 in a second embodiment of the present teaching will be described with reference to FIGS. 3, 6, 7, and 10. FIG. 6 is schematic views showing a maximum passage area B0 and a reference-obstacle-exclusion area B1 in the contact-move member-adjusting control of the end effector 1 according to the second embodiment. FIG. 7 is schematic views showing a position of the contact-move member 5 with respect to the maximum passage area B0 and the reference-obstacle-exclusion area B1 in the contact-move-member-adjusting control. Note that, in the following embodiment, specific description of similar points to those in the embodiment already described will be omitted and only a portion which differs from the already described embodiment will be described in detail.

As shown in FIG. 10, the end effector 1 is positioned in a predetermined posture at the imaging position P1 at which the stem G is included in the imaging range of the stereo camera 8. The stereo camera 8 captures the image I including the stem G from the imaging position P1. In this embodiment, the stereo camera 8 captures the image I while the end effector 1 is in a predetermined posture with the left-right direction thereof as the horizontal direction. The stereo camera 8 outputs data of the captured image I to the image processing unit 11.

As shown in FIGS. 6 and 7, by using the image processing program, the image processing unit 11 obtains, by image processing, a maximum passage area B0 of a predetermined shape with the stem G as a reference in the image I that is captured while the end effector is in the predetermined posture. The maximum passage area B0 includes areas through which the distal end portion of the first contact-move member 5L and the distal end portion of the second contact-move member 5R are predicted to pass when the end effector 1 moves from the imaging position P1 to the grabbing position P2 (see FIG. 10) in a state where the first contact-move member 5L is located at the first initial position Pa1 and the second contact-move member 5R is located at the second initial position Pa2.

The maximum passage area B0 includes, in the image I, an area through which the first contact-move member 5L and the second contact-move member 5R are predicted to pass when the first contact-move member 5L located at the first initial position Pa1 and the second contact-move member 5R located at the second initial position Pa2 move in a direction approaching each other at the grabbing position P2. The maximum passage area B0 includes the stem G, but is free of obstacles obstructing movement of the first contact-move member 5L and the second contact-move member 5R.

A width of the maximum passage area B0 in the left-right direction is defined, for example, by an interval between a left outer end of an area through which the distal end portion of the first contact-move member 5L located at the first initial position Pa1 is predicted to pass and a right outer end of an area through which the distal end portion of the second contact-move member 5R located at the second initial position Pa2 is predicted to pass, with the stem G as a reference in the image I. A width of the maximum passage area B0 in the up-down direction has, for example, a predetermined width in the up-down direction with the stem G as a reference in the image I.

Next, the image processing unit 11 determines whether the obstacles are included in the maximum passage area B0. When the image processing unit 11 determines that the obstacles are included in the maximum passage area B0, the image processing unit 11 obtains, by image processing, a reference-obstacle-exclusion area B1 that is an obstacle exclusion area in which at least one of a position, a rotation angle, or a size has been changed from the maximum passage area B0, with the stem G as a reference.

In this embodiment, the reference-obstacle-exclusion area B1 is a rectangular-shaped area constituted by sides extending in the left-right direction that is the moving direction of the first contact-move member 5L and the second contact-move member 5R, and sides extending in the up-down direction orthogonal to the left-right direction. The reference-obstacle-exclusion area B1 includes the target-object-grabbing area A1, the first-contact-move-member-passage area A21, and the second-contact-move-member-passage area A22.

When the image processing unit 11 determines, in the image I, that the stem G is included in the target-object-grabbing area A1 within the maximum passage area B0, without including the obstacles and the stem G in the first-contact-move-member-passage area A21 and the second-contact-move-member-passage area A22, the image processing unit 11 sets the maximum passage area B0 as the reference-obstacle-exclusion area B1.

A position and a posture of the end effector 1 is adjusted in accordance with the selected reference-obstacle-exclusion area B1 by the work machine. A position and a rotation angle of each of the first contact-move member 5L and the second contact-move member 5R in the end effector 1 are changed such that the first contact-move member 5L passes through the first-contact-move-member-passage area A21 and the second contact-move member 5R passes through the second-contact-move-member-passage area A22.

The control device 9 obtains, based on information such as a position, a size, and a shape of the reference-obstacle-exclusion area B1, and the distance L (see FIG. 10), the first adjusted position Pb1 that is a position, with respect to the body member 2, of the first contact-move member 5L passing through the first space when the end effector 1 moves from the imaging position P1 to the grabbing position P2. Similarly, the control device 9 obtains the second adjusted position Pb2 that is a position, with respect to the body member 2, of the second contact-move member 5R passing through the second space when the end effector 1 moves from the imaging position P1 to the grabbing position P2.

The control device 9 supplies electric power to the positioning mechanism actuator 4 by the actuator control unit 10 based on the obtained first adjusted position Pb1 and second adjusted position Pb2. The positioning mechanism actuator 4 moves the first contact-move member 5L from the first initial position Pa1 toward the first adjusted position Pb1 in the direction approaching the reference line D. Similarly, the positioning mechanism actuator 4 moves the second contact-move member 5R from the second initial position Pa2 toward the second adjusted position Pb2 in the direction approaching the reference line D.

The control device 9 of the end effector 1 thus configured changes the position, the rotation angle, and the size of the maximum passage area B0 to obtain, by image processing, the reference-obstacle-exclusion area B1 that includes the stem G but is free of the obstacles. The end effector 1 can approach the stem G while suppressing contact of the first and second contact-move members 5L, 5R with objects except the stem G. This can suppress interference between the end effector 1 and the obstacles around the target object without highly precisely moving the work machine that moves the end effector 1. It is, therefore, possible to improve the harvest rate of, e.g., fruit with the stem G.

### Third Embodiment

<Maximization of Interval Between Contact-Move Members>

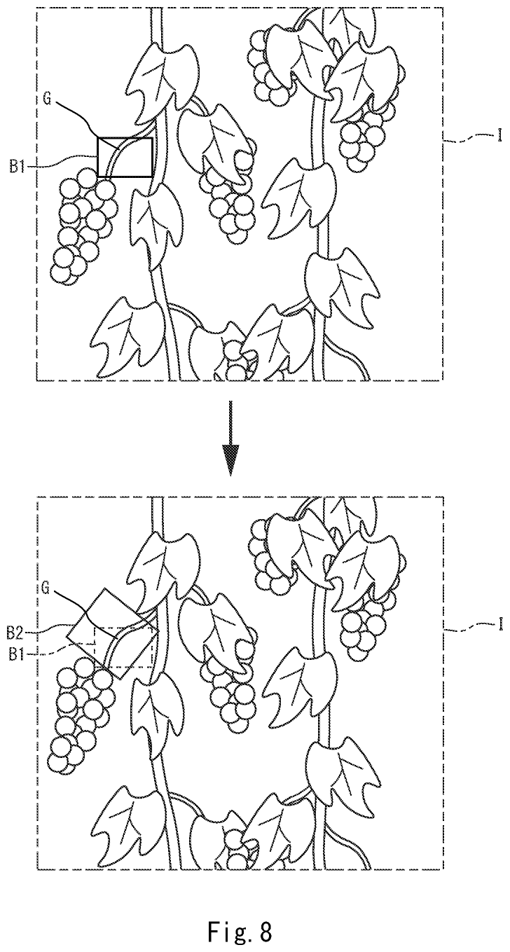

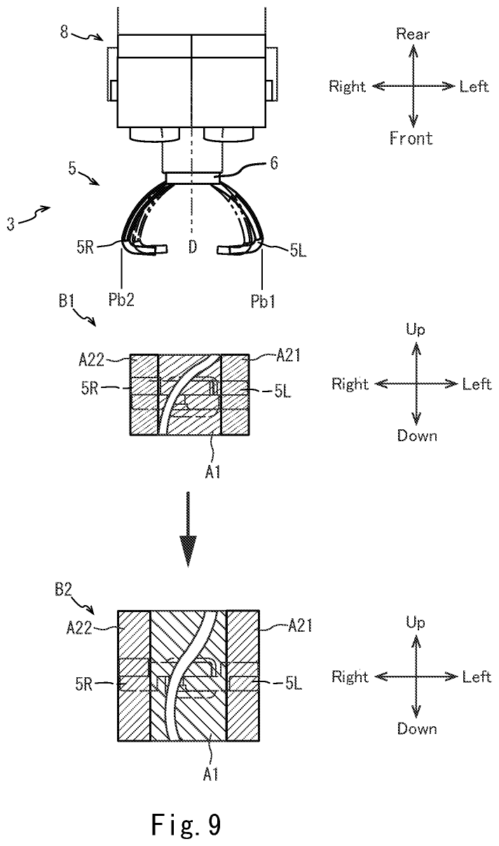

A third embodiment of a contact-move-member-adjusting control of the end effector 1 in the present teaching will be described with reference to FIGS. 3, 8 and 9. FIG. 8 is schematic views showing the reference-obstacle-exclusion area B1 and a corrected-obstacle-exclusion area B2 in the contact-move-member-adjusting control of the end effector 1 in the third embodiment. FIG. 9 is schematic views showing a position of the contact-move member 5 with respect to the reference-obstacle-exclusion area B1 and the corrected-obstacle-exclusion area B2 in the contact-move-member-adjusting control.

The image processing unit 11 obtains, by image processing, the reference-obstacle-exclusion area B1 with the stem G as a reference in the image I that is captured while the end effector 1 is in a predetermined posture by using the image processing program, where the reference-obstacle-exclusion area B1 has a predetermined shape and is constituted by the target-object-grabbing area A1, the first-contact-move-member-passage area A21, and the second-contact-move-member-passage area A22. The image processing unit 11 obtains an interval between the first-contact-move-member-passage area A21 and the second-contact-move-member-passage area A22 in the reference-obstacle-exclusion area B1.

Next, the image processing unit 11 obtains, by image processing, a plurality of corrected-obstacle-exclusion areas B2, in each of which at least one of a position, a rotation angle, or a size has been changed from the reference-obstacle-exclusion area B1 with the stem G positioned in the target-object-grabbing area A1. The image processing unit 11 selects one corrected-obstacle-exclusion area B2 from among the plurality of corrected-obstacle-exclusion areas B2 in the image I based on predetermined conditions.

In this embodiment, the image processing unit 11 selects, in the image I, the reference-obstacle-exclusion area B1 or the corrected-obstacle-exclusion area B2 that has the largest interval between the first-contact-move-member-passage area A21 and the second-contact-move-member-passage area A22, from among the obtained reference-obstacle-exclusion area B1 and the obtained corrected-obstacle-exclusion areas B2.

The position and posture of the end effector 1 are adjusted in accordance with the selected reference-obstacle-exclusion area B1 or corrected-obstacle-exclusion area B2 by the work machine. Furthermore, the position and rotation angle of each of the first contact-move member 5L and the second contact-move member 5R with respect to the body member 2 are changed in the end effector 1.

The control device 9 obtains, based on information such as a position, a size, and a shape of the reference-obstacle-exclusion area B1 or the corrected-obstacle-exclusion area B2, and the distance L, the first adjusted position Pb1 that is a position, with respect to the body member 2, of the first contact-move member 5L passing through the first space when the end effector 1 moves from the imaging position P1 to the grabbing position P2. Similarly, the control device 9 obtains the second adjusted position Pb2 that is a position, with respect to the body member 2, of the second contact-move member 5R passing through the second space.

The control device 9 moves, based on the obtained first adjusted position Pb1 and second adjusted position Pb2, the first contact-move member 5L from the first initial position Pa1 toward the first adjusted position Pb1 and the second contact-move member 5R from the second initial position Pa2 toward the second adjusted position Pb2, by the actuator control unit 10.

The control device 9 of the end effector 1 thus configured changes the position, the rotation angle, and the size of the reference-obstacle-exclusion area B1 to thereby maximize the interval between the first contact-move member 5L and the second contact-move member 5R within a range in which the end effector 1 is free of contact with the obstacles when moving from the imaging position P1 to the grabbing position P2. The end effector 1 can make a range in which the stem G can be grabbed as large as possible while suppressing interference with objects except the stem G. This can suppress interference between the end effector 1 and the obstacles around the target object without highly precisely moving the work machine that moves the end effector 1, and thereby improve the harvest rate of, e.g., fruit with the stem G.

<Multi-Joint Robot Arm Device>

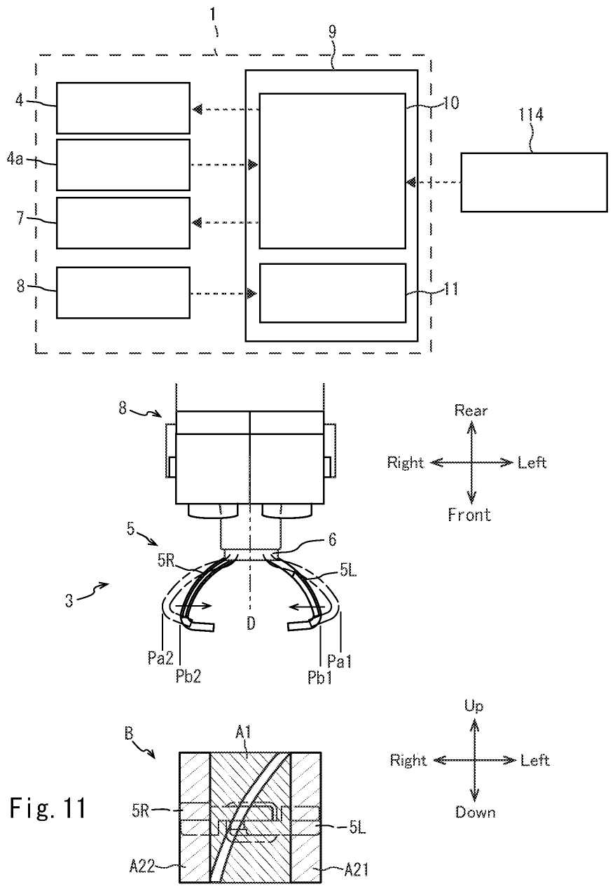

Next, a multi-joint robot arm device 100, which is a work machine with six degrees of freedom provided with the end effector 1, will be described. FIG. 10 is a schematic view showing the end effector 1 supported by the multi-joint robot arm device 100. FIG. 11 is a block diagram showing the control configuration of the end effector 1 provided in the multi-joint robot arm device 100, as well as schematic views showing the obstacle exclusion area B, the contact-move member 5 before adjustment, and the contact-move member 5 after adjustment.

Hereinafter, arrow “Z” in the drawing indicates an upward direction of the multi-joint robot arm device 100. Arrow “Y” in the drawing indicates a forward direction of the multi-joint robot arm device 100. The multi-joint robot arm device 100 includes a multi-joint robot arm 101, the end effector 1, and the robot-arm-control device 114 (see FIGS. 1 and 2).

<Multi-Joint Robot Arm 101>

As shown in FIG. 10, the multi-joint robot arm 101 is a robot arm of a serial link mechanism in which links 103 are connected in series from a proximal end to a distal end via rotary joints each having one degree of freedom (motor unit 102). The multi-joint robot arm 101 is, for example, a vertical multi-joint robot arm 101 having movable sections of six degrees of freedom. The multi-joint robot arm 101 is provided in, e.g., a remotely operated vehicle 200.

In the multi-joint robot arm 101, six motor units 102 are connected in series via the links 103 sequentially from the proximal end portion fixed to the remotely operated vehicle 200. The motor units 102 of respective axes each constitute the rotary joint. The multi-joint robot arm 101 is controlled by the robot-arm-control device 114 (see FIG. 11). A configuration of the multi-joint robot arm 101 is similar to that of a general multi-joint robot arm. Therefore, a detailed description of the multi-joint robot arm 101 is omitted. The configuration of the multi-joint robot arm 101 is not limited to the configuration illustrated in each drawing, as long as the configuration enables the end effector 1 to work on the stem G.

<Robot-Arm-Control Device>

As shown in FIG. 11, the robot-arm-control device 114 is a device for controlling the multi-joint robot arm 101 and the end effector 1. The robot-arm-control device 114 controls the multi-joint robot arm 101 and the end effector 1 so as to allow the end effector 1 to grab the stem G located within a working range that is within reach of the end effector 1. The robot-arm-control device 114 stores various image processing programs and data to control operations of the multi-joint robot arm 101 and the end effector 1.

The robot-arm-control device 114 is electrically connected to the control device 9 of the end effector 1 by a signal line and a power line. The robot-arm-control device 114 can output a control signal as the higher-level control device of the control device 9.

The robot-arm-control device 114 moves the end effector 1 by the multi-joint robot arm 101. The robot-arm-control device 114 positions the end effector 1 by the multi-joint robot arm 101 such that the stem G is included in the imaging range of the stereo camera 8 provided in the end effector 1. The robot-arm-control device 114 also moves the end effector 1 from the imaging position P1 to the grabbing position P2 by the multi-joint robot arm 101.

### OTHER EMBODIMENTS

The embodiments of the present teaching have been described above, but the above-described embodiments are merely illustrative examples of preferred embodiments of the present teaching. Therefore, the present teaching is not limited to the above-described embodiments and the above-described embodiments can be appropriately modified and implemented without departing from the gist of the teaching.

In each of the above-described embodiments, the image processing unit 11 of the control device 9 obtains, by image processing, the rectangular-shaped area including the stem G as the obstacle exclusion area B. Alternatively, the image processing unit 11 may obtains, by image processing, an area of a polygonal or circular shape as the obstacle exclusion area B. The image processing unit 11 may obtains by image processing, for example, an area of a hexagonal shape as the obstacle exclusion area B.

The end effector obtains, by image processing, the first-contact-move-member-passage area and the second-contact-move-member-passage area such that the first contact-move member and the second contact-move member pass near vertexes of the obtained obstacle exclusion area of a polygonal shape. This allows the first contact-move member 5L and the second contact-move member 5R to have the widest interval therebetween in the obstacle exclusion area. Furthermore, in the case of the obstacle exclusion area of a circular shape, the image processing unit 11 can obtain, by image processing, the obstacle exclusion area without considering an angle to the obstacles. This can suppress interference between the end effector 1 and the obstacles around the target object without highly precisely moving the work machine that moves the end effector 1. It is, therefore, possible to improve the harvest rate of, e.g., fruit with the stem G.

In each of the above-described embodiments, the first-contact-move-member-passage area A21 is located to the left of the target-object-grabbing area A1 in the image I. The second-contact-move-member-passage area A22 is located to the right of the target-object-grabbing area A1 in the image I. Alternatively, it suffices that the areas through which the first contact-move member and the second contact-move member are predicted to pass are located around the target-object-grabbing area A1 in the image I. The areas through which the first contact-move member and the second contact-move member are predicted to pass may be, for example, located above and below the target-object-grabbing area A1 in the image I.

In each of the above-described embodiments, the end effector 1 includes the stereo camera 8 constituted by the two monocular cameras as an imaging device. Alternatively, the imaging device may be other than a stereo camera. A device, which can calculate the distance from the imaging position to the target object and capture an image including the target object, suffices as the imaging device. The imaging device may be a LiDAR (light detection and ranging) device that uses a laser beam to measure the distance to the object including the target object.

In each of the above-described embodiments, the positioning mechanism actuator 4 is constituted by the electric cylinder that moves the piston rod in an axial direction by the electric motor. Alternatively, an actuator capable of moving the first contact-move member and the second contact-move member suffices as the positioning mechanism actuator.

In each of the above-described embodiments, the target-object-positioning mechanism 3 includes the first contact-move member 5L and the second contact-move member 5R. Alternatively, it suffices that the target-object-positioning mechanism 3 includes a plurality of contact-move members. The target-object-positioning mechanism 3 may include, for example, three contact-move members.

In each of the above-described embodiments, the first contact-move member 5L and the second contact-move member 5R are configured to move in conjunction with each other by the same amount of movement in the direction approaching each other or in the direction away from each other in the left-right direction by the positioning mechanism actuator 4. Alternatively, the first contact-move member and the second contact-move member may be configured to be movable independently of each other in the left direction and in the right direction. In other words, each of the first contact-move member and the second contact-move member may be configured to be moved in an arbitrary direction and by an arbitrary distance by each individual positioning mechanism actuator. This allows the image processing unit 11 to determine, in the obstacle exclusion area B, the positions of the first-contact-move-member-passage area and the second-contact-move-member-passage area with respect to the stem G independently of each other.

In the third embodiment described above, the image processing unit 11 selects, in the image I, the reference-obstacle-exclusion area B1 or the corrected-obstacle-exclusion area B2 with the largest interval between the first-contact-move-member-passage area A21 and the second-contact-move-member-passage area A22. Alternatively, the image processing unit may select the corrected-obstacle-exclusion area based on other conditions. For example, the image processing unit may select the corrected-obstacle-exclusion area that is a predetermined distance or more away from e.g., surrounding leaves, stems, branches, fruits, and stalks.

In the above-described embodiments, the multi-joint robot arm 101 is configured, as an example, such that an S-axis motor unit, an L-axis motor unit, a U-axis motor unit, a B-axis motor unit, an R-axis motor unit, and a T-axis motor unit are connected in series via the links. As for, e.g., a connection order in which the motor units of the respective axes of the multi-joint robot arm 101 are connected, and axial directions when the axes are connected, any configuration may be used as long as the configuration can function as the multi-joint robot arm 101.

### REFERENCE SIGNS LIST

1 end effector
2 body member
3 target-object-positioning mechanism
4 positioning mechanism actuator (actuator for positioning mechanism)
4a encoder
5 contact-move member
5L first contact-move member
5R second contact-move member
6 processing mechanism
7 processing mechanism actuator (actuator for processing mechanism)
8 stereo camera
9 control device
10 actuator control unit
11 image processing unit
100 multi-joint robot arm device
101 multi-joint robot arm
114 robot-arm-control device
200 remotely operated vehicle
G grape stem
A1 target-object-grabbing area
A21 first-contact-move-member-passage area
A22 second-contact-move-member-passage area
B obstacle exclusion area
B0 maximum passage area
B1 reference-obstacle-exclusion area
B2 corrected-obstacle-exclusion area
D reference line
P1 imaging position
P2 grabbing position
Pa1 first initial position
Pa2 second initial position
Pb1 first adjusted position
Pb2 second adjusted position

1. An end effector that is movable by a work machine for grabbing a target object, the end effector comprising:
a body member configured to be supported by the work machine;
a target-object-positioning mechanism coupled to the body member;
an imaging device provided at the body member, the imaging device being configured to capture an image including the target object at an imaging position; and
a control device configured to control
the target-object-positioning mechanism based on the image captured by the imaging device, wherein
the target-object-positioning mechanism includes:
a contact-move member configured to make contact with at least a part of the target object, to thereby grab the target object at a grabbing position, the contact-move member including
a first contact-move member configured to move in a first direction with respect to the body member, the first direction being orthogonal to a front-rear direction which is a direction from the body member to the grabbing position or from the grabbing position to the body member,
a second contact-move member configured to move in a second direction orthogonal to the front-rear direction, and
an actuator configured to move the first contact-move member in the first direction and to move the second contact-move member in the second direction;
the control device is configured to obtain in the captured image, by processing the image,
a passage area through which the first contact-move member and the second contact-move member are predicted to pass when the end effector is moved from the imaging position to the grabbing position and when the first contact-move member and the second contact-move member are moved with the end effector located at the grabbing position, the passage area including an obstacle exclusion area that has a predetermined shape, and that includes the target object but is free of any obstacle that obstructs movement of the first contact-move member and the second contact-move member, wherein the obstacle exclusion area includes
a first-contact-move-member-passage area that is free of the target object and through which a distal end portion of the first contact-move member is predicted to pass,
a second-contact-move-member-passage area that is free of the target object and through which a distal end portion of the second contact-move member is predicted to pass, and
a target-object-grabbing area located between the first-contact-move-member-passage area and the second-contact-move-member-passage area, the target object being in the target-object-grabbing area;
the control device is further configured to cause at least one of the first contact-move member or the second contact-move member to move with respect to the body member by the actuator, such that
the first contact-move member passes through a first space that is defined by extending the first-contact-move-member-passage area in a moving direction of the end effector, and
the second contact-move member passes through a second space that is defined by extending the second-contact-move-member-passage area in the moving direction of the end effector,
when the end effector is moved from the imaging position to the grabbing position.

2. The end effector according to claim 1, wherein the control device is further configured to
obtain in the image, by processing the image, a maximum passage area through which the first contact-move member and the second contact-move member with a widest interval therebetween are predicted to pass when the end effector is moved from the imaging position to the grabbing position and when the first contact-move member and the second contact-move member are moved with the end effector located at the grabbing position, and
change at least one of a position, an angle, or a size of the maximum passage area to position the target object within the target-object-grabbing area.

3. The end effector according to claim 1, wherein
the control device is configured to
change at least one of a position, an angle, or a size of the obstacle exclusion area with respect to the target object, to thereby maximize an interval between the first-contact-move-member-pas sage area and the second-contact-move-member-passage area when the end effector is moved from the imaging position to the grabbing position with the target object located within the target-object-grabbing area in the image, and
cause at least one of the first contact-move member or the second contact-move member to move by the actuator such that the first contact-move member passes through the first space and the second contact-move member passes through the second space, in the changed obstacle exclusion area.

4. The end effector according to claim 3, wherein
the obstacle exclusion area is of a polygonal shape or a circular shape.

5. The end effector according to claim 2, wherein
the obstacle exclusion area is of a polygonal shape or a circular shape.

6. The end effector according to claim 2, wherein
the first-contact-move-member-passage area and the second-contact-move-member-passage area are located around the target-object-grabbing area.

7. The end effector according to claim 1, wherein
the first-contact-move-member-passage area and the second-contact-move-member-passage area are located around the target-object-grabbing area.

8. The end effector according to claim 1, wherein
the obstacle exclusion area is of a polygonal shape or a circular shape.
